(19) United States
(12) Patent Application Publication
(10) Pub. No.: US 2010/0324160 A1
(43) Pub. Date: Dec. 23, 2010

(54) Composite Containing Modified Hybride Resin Based on Natural Fatty Acids

(75) Inventors: Nina Heiskanen, Helsinki (FI); Salme Koskimies, Helsinki (FI); Saila Jämsa, Espoo (FI); Leena Paajanen, Helsinki (FI); Pirjo Ahola, Espoo (FI); Martti Wikstedt, Vantaa (FI); Satu Laamanen, Espoo (FI)

Correspondence Address: BIRCH STEWART KOLASCH & BIRCH, PO BOX 747, FALLS CHURCH, VA, 22040-0747, US

(73) Assignee: Valtion teknillinen tutkimuskeskus, Espoo (FI)

(21) Appl. No.: 12/224,595

(22) PCT Filed: Mar. 2, 2007
(86) PCT No.: PCT/FI2007/050116

§ 371 Date: Oct. 30, 2008

(30) Foreign Application Priority Data
Mar. 6, 2006 (FI) 20065150

(51) Int. Cl. C08L 97/02; C08J 11/04

(52) U.S. Cl. 521/48; 524/14

(57) ABSTRACT

The invention relates to natural fatty acid based hybride resin, modified with reactive monomers, and to a method for preparing it. The invention also relates to the use of the modified natural fatty acid based hybride resin as binding agent especially in water based coatings, glues and composites, and as environmentally friendly wood impregnating agent. The modified natural fatty acid based hybride resin comprises the condensation product of natural fatty acid or natural fatty acid ester, modified with di- or oligo-carboxylic acid or anhydride or half ester, and natural fatty acid based alkyd resin.

### FIELD OF THE INVENTION

The invention relates to the use of natural fatty acid based hybride resin, modified with reactive monomers, in composites and combination products, as well as to composites containing natural fatty acid based hybride resins modified with reactive monomers.

### STATE OF THE ART

Use of products, such as biocomposites, manufactured from renewable raw materials or biomaterials is continuously increasing. This is because of many good properties of these products, which are among other things biodegradability, recyclability and low toxicity. Of their volume the most important ones of present biocomposites are linen, hemp and wood fibre based composites. In order to reach as high proportion of raw materials derived from natural materials in biocomposites as possible it is generally desirable that also the auxiliary agents used in the preparation are biobased.

Methods for producing water based modified alkyd resins for coating applications are known e.g. from U.S. Pat. No. 4,436,849, U.S. Pat. No. 4,346,044 and JP 85-170952 publications. A semidrying alkyd resin according JP 85-170952 or an alkyd resin according to U.S. Pat. No. 4,436,849 prepared from linen seed oil and containing cyanuronic groups, is allowed to react with maleic anhydride to provide a modified alkyd resin product. In the publication U.S. Pat. No. 4,346,044 an alkyd resin prepared from soybean oil is modified with hexahydrophthalic anhydride.

According to the publication WO 9921900 a plant oil or animal fat modified with maleic anhydride can be used as such in the preparation of biocomposites and especially linen based fibre biocomposites. However, the uniform application of the auxiliary agent into the fibre is then problematic.

Based on the above it can be seen that there exists an obvious need to provide composite products, which contain as binding agents and/or compatibilisators natural fatty acid based, water-soluble alkyd resin products having improved properties.

### OBJECT OF THE INVENTION

The object of the invention is to provide composites containing modified natural fatty acid based hybride resins, as well as a method for the preparation of these composites.

Another object of the invention is to provide biocomposites containing modified natural fatty acid based hybride resins, as well as a method for the preparation of these biocomposites.

Another object of the invention is the use of modified natural fatty acid based hybride resins as compatibilisators and binding agents (binders) in composites.

The characteristic features of the composites according to the invention containing modified natural fatty acid based hybride resins, of the method for their preparation and the use of the modified natural fatty acid based hybride resins are presented in the patent claims.

Hybride resin refers here to a condensation product of a modified natural fatty acid mixture and an alkyd resin.

### SUMMARY OF THE INVENTION

The invention relates to composites containing modified natural fatty acid based hybride resins, especially biocomposites, to a method for the preparation thereof and to the use of modified natural fatty acid based hybride resins in composites and combination products.

The composites according to the invention comprise modified natural fatty acid based hybride resins, which comprise condensation products of natural fatty acid mixtures or natural fatty acid ester mixtures, modified with di- and/or oligo-carboxylic acids or di- and/or oligo-carboxylic anhydrides or di- and/or oligo-carboxylic acid half esters, and natural fatty acid based alkyd resins, natural material and optionally other material and adhesive agents.

The method for the preparation of modified natural fatty acid based hybride resins comprises the steps, wherein in step 1) natural fatty acid mixture or natural fatty acid ester mixture, selected from fatty acid mixtures and fatty acid ester mixtures obtained from natural oils and fats, plant based fatty acid mixtures and natural oils containing fatty acid esters, is modified with a di- and/or oligo-carboxylic acid or di- and/or oligo-carboxylic anhydride or di- and/or oligo-carboxylic acid half ester, and in step 2) the product obtained from step 1 and natural fatty acid based alkyd resin are condensed, wherein a modified natural fatty acid based hybride resin is obtained as product, which is optionally dispersed in water.

Fatty acid mixtures and fatty acid ester mixtures, which may also be oligomeric and polymeric products, can be obtained from natural oils and fats with any known method, e.g. by hydrolysing directly or via intermediate steps.

The modified natural fatty acid based hybride resins thus obtained can be used as binding agents and compatibilisators in combination products and composites, especially in biocomposites.

### DETAILED DESCRIPTION OF THE INVENTION

It was surprisingly found that modified natural fatty acid based hybride resins can be used as binding agents and compatibilisators in combination products and composites, especially suitably biocomposites, and said modified natural fatty acid based hybride resins can be produced from natural fatty acid mixtures or natural fatty acid ester mixtures, modified with di- and/or oligo-carboxylic acid or di- and/or oligo-carboxylic anhydride or di- and/or oligo-carboxylic acid half ester, by condensing them with natural fatty acid based alkyd resins, and the hybride resins thus obtained can optionally further be dispersed in water whereby they form a stable emulsion.

The properties of the thus obtained modified natural fatty acid based hybride resin products, such as water dispersibility, adhesive properties and penetrability especially to natural materials such as e.g. into wood, wood fibres, hemp and linen, are excellent.

Natural fatty acid mixtures and natural fatty acid ester mixtures exist e.g. in plants, trees and especially in natural oils, tall oil fatty acid mixtures and in fatty acid mixtures of suberin and cutin. Natural oils refer here to natural oils containing conjugated or non-conjugated double bonds, such as a plant oils, preferably linen seed oil, soybean oil, rapeseed oil, rape oil, sunflower oil etc.

Natural fatty acid mixture and natural fatty acid ester mixture refers in this connection to a mixture that comprises unsaturated and saturated fatty acids or corresponding fatty acid esters having the carbon number in the range between C12 and C20.

Tall oil fatty acid mixture refers especially to fatty acid mixture separated from tall oil side product of wood processing industry, the typical fatty acid composition of which is presented in the following. The fatty acid mixture of tall oil contains about 50% (45-55%) of linolic acid and other diunsubstituted C₁₈ fatty acids, including conjugated acids, about 35% (30-45%) of oleic acid, about 7% (2-10%) of polyunsaturated fatty acids, about 2% (0.5-3%) of saturated fatty acids and at most 3% (0.5-3%) of rosin acids as weight percents.

The suggested fatty acid compositions of some natural acids are presented in the following Table 1:

TABLE 1

| | Fatty acid composition (% by weight) | | | |
|---|---|---|---|---|
| | Soy | Linen seed | Rapeseed | Tall oil fatty |
| Fatty Acid | oil | oil | oil | acid mixture |
| saturated | | | | |
| C₁₄ myristic acid | 0.1 | | | |
| C₁₆ palmitic acid | 10.5 | 6 | 5 | |
| C₁₈ stearic acid | 2 | 3.5 | 2 | 2 |
| C₂₀ arachidic acid | 0.2 | | | 1 |
| unsaturated | | | | |
| C_{16:1} palmitoleic acid | | 0.5 | | |
| C_{18:1} oleic acid | 22.3 | 19 | 63 | 59 |
| C_{20:1} eicosenoic acid | 0.9 | | 1 | 1 |
| C_{18:2} linolic acid | 54.5 | 14 | 20 | 37 |
| C_{18:3} linolenic acid | 8.3 | 57 | 9 | |
| altogether | 98.8 | 100 | 100 | 100 |

The modified natural fatty acid based hybride resin, useful in the invention, is a condensation product of natural fatty acid mixture or natural fatty acid ester mixture, modified with di- and/or oligo-carboxylic acid or anhydride or half ester, and natural fatty acid based alkyd resin. The natural fatty acid mixture or natural fatty acid ester mixture comprises fatty acid mixture or fatty acid ester mixture selected from the group consisting of tall oil fatty acids, suberin fatty acids, cutin fatty acids and plant oils, preferably tall oil fatty acids, suberin fatty acids, linen seed, soy, rapeseed, rape, sunflower and olive oil and their mixtures.

Natural fatty acid based alkyd resin refers here to alkyd resin, which is prepared by condensing from 20-80, preferably 40-75% by weight of natural fatty acid starting materials or a mixture thereof, in which the proportion of conjugated fatty acids can be 0-70% by weight, from 1-45, preferably 5-30% by weight of one or more polyols, from 5-45, preferably 10-39% by weight of one or more polybasic acids and optionally from 0-15% by weight of one or more monobasic acids. The fatty acid starting material comprises natural fatty acid mixture or natural fatty acid ester mixture selected from the group consisting of tall oil fatty acids, suberin fatty acids, cutin fatty acids, plant oils and their mixtures, preferably tall oil fatty acids, suberin fatty acids, linen seed, soy, rapeseed, rape, sunflower and olive oil. The polyol is selected from the group consisting of glycerol, pentaerythritol, trimethylolpropane, neopentyl glycol and their mixtures. The polybasic acid is selected from the group consisting of di- and polyacids and their anhydrides, preferably the polybasic acid is phthalic anhydride, isophthalic acid or terephthalic acid. The monobasic acid is selected from the group consisting of aromatic monoacids and aliphatic C₄-C₂₀ carboxylic acids, preferably from valeric acid (n-pentanoic acid) and benzoic acid.

The alkyd resin is prepared by condensing the polyol(s), mono-, di- and/or polyacid(s) or anhydride and the free fatty acid starting material(s) together under an inert gas at a temperature of 200-270° C., preferably 220-260° C.

When fatty acid esters such as plant oils are used in the preparation of the alkyd resin, the fatty acid esters are first allowed to react at a temperature of 150-240° C., preferably 180-200° C. with an excess of a polyol in an ester exchange reaction called alcoholysis, wherein to the equilibrium mixture free hydroxyl groups are obtained which can react further under an inert gas with mono-, di- and/or polyacids or anhydrides at a temperature of 200-270° C., preferably 220-260° C. Commonly used alcoholysis catalysts are lithium hydroxide, calcium oxide and sodium hydroxide. In the alcoholysis, the polyol is typically used twice the molar amount of the oil; the oil:polyol molar ratio is typically 1.0:1.2-1.0:3.0, preferably 1.0:1.5-1.0:2.0.

The molar mass of the alkyd resins thus obtained is typically <20,000 g/mol, preferably 2,000-10,000 g/mol and the acid number is typically <25, preferably <15.

According to the invention also natural fatty acid based alkyd resin can be used which is modified with maleic anhydride or C₁-C₂₀ alkyl/alkenyl derivatives of maleic anhydride or di- and half esters of maleic anhydride. The fatty acid based alkyd resin is warmed to a temperature of 100-200, preferably 150-180° C., then maleic anhydride or its derivative (5-35 mol %, preferably 10-20 mol % of the fatty acid content of the alkyd) is added in small portions during 0.5-2 hours, after which the reaction mixture is warmed to 150-220, preferably 180-200° C. and agitated for a further 1-5 hours. As a final product a modified alkyd resin is obtained having a higher acid functionality as the alkyd resin starting material.

A method according to one embodiment, for the preparation of modified natural fatty acid based hybride resins, comprises the steps, where in step 1) natural fatty acid mixture or natural fatty acid ester mixture selected from the group consisting of fatty acid mixtures obtained from natural oils, plant based fatty acid mixtures and natural oils containing fatty acid esters, such as triglyceride esters, is modified with a di- and/or oligo-carboxylic acid or anhydride or half ester containing free acid groups of maleic anhydride, and in step 2) the product obtained from step 1 and natural fatty acid based alkyd resin are condensed, whereby a modified natural fatty acid based hybride resin is obtained as product, which is optionally dispersed in water.

In the following Scheme 1 the first step of the method is presented, wherein di- and/- or oligo-carboxylic acid or anhydride or half ester, in Scheme 1 maleic anhydride (1) or maleic acid (2) reacts with the double bond of conjugated (3) or non-conjugated (4) natural fatty acid forming as products (5), (6) and (7) according to Scheme 1.

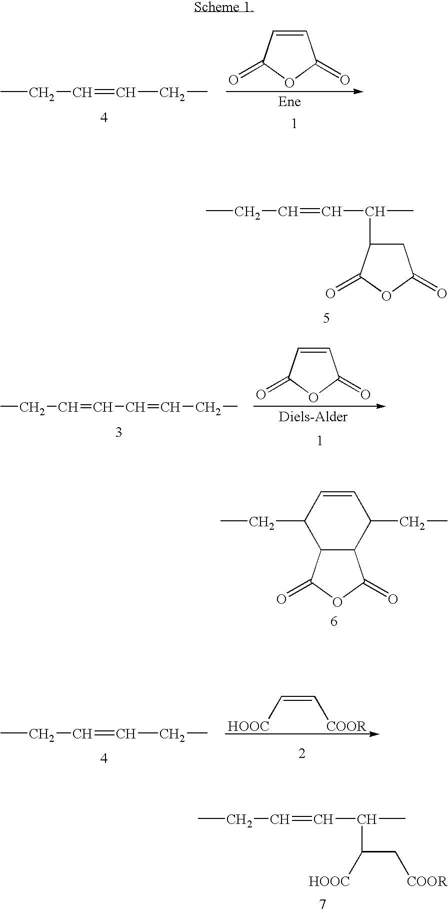

In the method, in step 1) natural fatty acid mixture or natural fatty acid ester mixture, which can be non-conjugated or conjugated, is modified with reactive monomers. The modified natural fatty acid mixture or ester mixture is condensed to an alkyd structure through reacting via transesterification or via double bond addition wherein the desired hybride resin is formed. The modified hybride resin thus obtained may optionally be dispersed further in water.

As reactive monomers suitable di- and/or oligo-carboxylic acids and anhydrides and half esters are selected from the group consisting of itaconic anhydride, fumaric anhydride, C2-C18 alkylene maleic anhydrides, C2-C18 alkylene maleic acids, maleic acid, maleic anhydride, fumaric acid, itaconic acid as well as half esters of above mentioned acids, including oligo-carboxylic acid derivatives such as suberic acid derivatives containing a reactive double bond. The reactive monomer is preferably maleic anhydride.

In the method, in the first step the modifying is accomplished by treating the natural fatty acid mixture or natural fatty acid ester mixture with 1-50, preferably 5-30 mol % (calculated from the fatty acid/ester) of a di- and/or oligo-carboxylic acid or anhydride or half ester at a temperature of 80-230, preferably 120-200° C. for 1-10, preferably 2-6 hours to give the expected modified non-conjugated or conjugated natural fatty acid mixture or natural fatty acid ester mixture.

The modified natural fatty acid mixture or natural fatty acid ester mixture, obtained in the method in the first step, is condensed in the second step of the method to an alkyd structure by allowing 15-50% by weight (calculated from the amount of alkyd resin) of the modified natural fatty acid mixture or natural fatty acid ester mixture to react with natural fatty acid based alkyd resin at a temperature of 50-150, preferably 80-120° C. for 1-8, preferably 2-6 hours, to give the desired modified hybride resin. The acid number of the modified hybride resin may vary between 15-95, preferably 35-85.

The hybride resins may optionally be dispersed or emulsified in water, whereby water based alkyd emulsion is obtained having dry matter content of 10-50, preferably 25-45% by weight. The pH of the hybride resin is adjusted with base between 6-10, preferably between 6, 5-9 and suitable bases are e.g. KOH as well as ammonia as water solutions and 2-dimethylaminoethanol. The neutralised hybride resin solution so obtained is dispersed/emulsified in water at temperature of 15-80° C., preferably 25-65° C.

Optionally 0-30% by weight of co-solvents selected from the group consisting of isopropanol, 2-butoxyethanol, methoxypropanol and propylene glycol butyl ether etc. can be used. Additionally, dispersing agents known in the art can also be used when required. The dispersing/emulsifying is preferably carried out with known mixers and/or homogenisers, which provide speeds of rotation of 100-50,000 rpm, preferably 100-25,000 rpm. Stable aqueous emulsions of the hybride resins are thus obtained. These hybride resins and especially their stable aqueous emulsions are well suited as binding agents and compatibilisators in the preparation of combination products and composites, such as preferably biocomposites. Composites can be produced from natural materials such as cellulose, wood, wood fibres, linen, hemp, starch and other natural fibres or their combinations, if required, with known additives, or alternatively in the composites together with natural materials another material can be used, which can be selected from the group consisting of thermoplastic plastics such as polyolefins, polyamides, polyesters, polyethylene terephthalates (PET), polylactides (PLA) and corresponding polymers, which polymers can be for example recycled material.

The composite according to the invention containing hybride resin comprises 1-50, preferably 5-30% by weight (calculated from dry matter) of modified natural fatty acid based hybride resin and 99-50, preferably 95-70% by weight of a natural material selected from the group consisting of cellulose, wood, wood fibre, linen, hemp, starch or other natural fibre or a combination thereof. Of the natural material, 20-80% by weight can be replaced with another material, which can be selected from the group of thermoplastic plastics such as polyolefins, polyamides, polyesters, polyethylene terephthalates (PET), polylactides (PLA) and corresponding polymers, which material is preferably recycled material, which has been milled or grinded as a finely divided crush. 30-70% by weight of the modified natural fatty acid based hybride resin can be replaced with another binding agent or adhesive, especially in wood board products such as plywood and veneer products with adhesives originating from the nature, such as starch and cellulose derivatives.

The composite according to the invention containing hybride resin can be produced by mixing 1-50, preferably 5-30% by weight of modified natural fatty acid based hybride resin either as such or as an aqueous emulsion, and 99-50, preferably 95-70% by weight of a natural material selected from the group consisting of cellulose, wood, wood fibre, linen, hemp, starch or other natural fibre or a combination thereof, or 20-80% by weight of the natural material may be replaced with another material, which can be selected from the group consisting of thermoplastic plastics such as polyolefins, polyamides, polyesters, polyethylene terephthalates (PET), polylactides (PLA) and corresponding polymers, which material is preferably a recycled material, which has been milled or grinded as a finely divided crush, and by forming and curing the product with aid of heat, e.g. by extrusion or hot-pressing at 100-250° C., preferably at 120-200° C. to a composite product of desired type. 30-70% by weight of the modified the natural fatty acid based hybride resin may be replaced with another binding agent or adhesive, especially in wood board products such as plywood and veneer products with adhesives originating from the nature, such as starch and cellulose derivatives.

The use of the modified natural fatty acid based hybride resin in combination products and composites brings several advances. The use of the hybride resin in composites reduces substantially the emissions of volatile organic substances from the products in question, because the need for using solvents and additives is substantially reduced.

Because the hybride resin also contains components originating from natural fatty acids or natural fatty acid esters containing double bonds, the compositions containing hybride resins dry quickly and conjugation enhances the drying. Additionally the hybride resins are compatible with natural materials such as own components of wood and their penetrability into the material to be treated is excellent.

The use of the hybride resin as binding agent and compatibilisator in combination products, composites and especially in natural material based composites such as linen, wood and hemp composites will promote the natural features, biodegradability and non-toxicity of the product. Additionally, the hybride resin is a reactive binding agent improving physical properties of the composite according to the invention, such as strength, water resistance and solvent resistance as well as the fixation and even distribution of the matrix material in the product.

The invention is described in more detail with the following examples, to which it is anyhow not meant to be restricted.

### EXAMPLES

### Example 1

### Modifying of Fatty Acid Mixture with Maleic Anhydride

Tall oil fatty acid mixture (400 g, 1.423 mol) containing a few percents of conjugated fatty acids was warmed to 180° C. Maleic anhydride (27.9 g, 0.285 mol, 20 mol %) was added in small portions during 2 hours, after which the reaction mixture was warmed to 200° C. and stirred for further 3 hours. According to NMR analysis no unreacted maleic anhydride was left in the reaction product (414 g).

### Example 2

### Modifying of Fatty Acid Mixture with Maleic Anhydride

Tall oil fatty acid mixture (2000 g, 7.114 mol) containing a few percents of conjugated fatty acids was warmed to 180° C. Maleic anhydride (139.5 g, 1.423 mol, 20 mol %) was added in small portions during 2 hours, after which the reaction mixture was warmed to 200° C. and stirred for further 3 hours. According to NMR analysis the reaction product (2119.8 g) didn't contain unreacted maleic anhydride.

### Example 3

### Modifying of Conjugated Fatty Acid Mixture with Maleic Anhydride

Conjugated tall oil fatty acid mixture (100 g, 0.356 mol) was warmed to 120° C. Maleic anhydride (10.5 g, 0.107 mol, 30 mol %) was added in small portions during 15 min, then the reaction mixture was warmed and agitated for 3 hours. According to NMR analysis the product (96.4 g) didn't contain unreacted maleic anhydride.

### Example 4

### Preparation of Tall Oil Based Alkyd Resin

Alkyd resin was prepared from tall oil fatty acids (1484.4 g), isophthalic acid (222.4 g) and trimethylolpropane (375.5 g). The starting materials were mixed and warmed at 250-260° C. The progress of reaction was followed with samples, from which acid number and when the reaction mixture became clear also viscosity (R.E.L. rotating cone/plate viscometer) were determined. The reaction was boiled for 11 hours. Acid number of the cooled product (1875.2 g) was 10.3 mgKOH/g and viscosity 2.4 Poise/50° C.

### Example 5

### Preparation of Tall Oil Based Alkyd Resin

Alkyd resin was prepared from tall oil fatty acids (372.6 g), isophthalic acid (55.9 g) and pentaerythritol (71.5 g). The starting materials were mixed and warmed at 240-260° C. with bubbling nitrogen into the reaction mixture. The progress of the reaction was followed with acid number, and when the reaction mixture became clear, also with viscosity (R.E.L.). The reaction was boiled for 11 hours. From the cooled product (420.3 g) acid number (5) and viscosity (8.7 Poise/50° C. and 10305 cP/RT (=room temperature) (Brookfield) were determined.

### Example 6

### Modifying of Tall Oil Fatty Acid Based Alkyd Resin with Maleic Anhydride

Starting material, the alkyd prepared in example 4 (400 g, acid number 10, viscosity 2.4 Poise/50° C.) was warmed to 180° C. Maleic anhydride (8.0 g, 0.163 mol, 15 mol % of the fatty acid content of the alkyd) was added in small portions during one hour, then the reaction mixture was warmed to 200° C. and stirred for a further 3 hours. 396.9 g of the final product was obtained, acid number was 19.7 mgKOH/g and viscosity 4.7 Poise/50° C.

### Example 7

### Preparation of Linen Seed Oil Based Alkyd Resin

An alkyd resin was prepared from linen seed oil (865.7 g), trimethylolpropane (402.0 g), isophthalic acid (300.0 g) and benzoic acid (294.3 g). Linen seed oil was warmed to a temperature of 150° C. with agitating (450 rpm) under nitrogen atmosphere, after which lithium hydroxide monohydrate (0.758 g) was added. The warming was continued to 200° C. and trimethylolpropane was added. The alcoholysis reaction was followed with aid of a solubility test and when the reaction mixture was fully soluble in methanol (about 2 hours), isophthalic acid was added to the reaction vessel, and after mixing the benzoic acid was added. The warming of the reaction mixture was continued at 200-220° C. and the progress of the reaction was followed with acid number, and when the reaction mixture became clear, also with viscosity. The reaction was boiled for 4 hours from the acid addition. From the cooled product (1713.6 g) acid number (21) and viscosity (5.2 Poise/50° C., R.E.L.) were determined.

### Example 8

### Preparation of Alkyd Resin with Conjugated Tall Oil Fatty Acid Mixture

Alkyd resin was prepared from tall oil fatty acid mixture (205.9 g), conjugated tall oil fatty acid mixture (52.85 g), isophthalic acid (74.8 g), benzoic acid (73.2 g), pentaerythritol (65.3 g) and trimethylolpropane (28.1 g). The starting materials were agitated and warmed at about 220-240° C. while bubbling nitrogen below the surface of the reaction mixture. The progress of the reaction was followed acid number, and when the reaction mixture became clear, also with viscosity (R.E.L.). The reaction was boiled for 7 hours. From the cooled product (400.1 g) acid number (13.5) and viscosity (4.6 Poise/75° C., R.E.L. and RT/47500 cP (Brookfield) were determined.

### Example 9

### Condensation of Maleic Anhydride-Modified Tall Oil Fatty Acid Mixture to Linen Seed Oil Based Alkyd Structure

A mixture of linen seed oil based alkyd of example 7 (1600 g, acid number 21 and viscosity 5.2 Poise/50° C.) and the maleic modified tall oil fatty acid mixture of example 2 (800 g, acid number 23) was mixed and warmed for 3 hours at 120° C. The addition/condensation product of alkyd resin and maleated oil obtained as product had an acid number of 83.5 and viscosity of 2.5 Poise/50° C.

### Example 10

### Modifying of Soybean Oil with Maleic Anhydride

Soybean oil (300 g, 0.340 mol) was weighed into a reaction vessel and warmed at 150-170° C. Maleic anhydride (20 g, 0.204 mol, 20 mol % of the fatty acid equivalent) was added in small portions during 2 hours, then the reaction mixture was warmed to 200° C., at which it was agitated for further 3 hours. The acid number of the reaction product (314 g) was 33.

### Example 11

### Preparation of Soybean Oil Based Alkyd Resin

Alkyd resin was prepared from soybean oil (300 g), trimethylolpropane (114 g) and isophthalic acid (109.8 g). The reaction mixture was warmed to a temperature of 180° C. with stirring under nitrogen atmosphere, after which lithium hydroxide monohydrate (0.3 g) was added. The warming was continued to 240° C., at which the reaction mixture was kept for 2 hours. The reaction mixture was cooled to 180° C. and the isophthalic acid was added. The reaction mixture was warmed again to 240-250° C. and the progress of the reaction was followed with acid number and viscosity. The reaction time after addition of the isophthalic acid was 2 hours. The acid number of the product (446.8 g) was 5 and viscosity 3.0 Poise/75° C. (R.E.L.).

### Example 12

### Condensation of Maleic Modified Soybean Oil to Soybean Oil Based Alkyd and Preparation of Emulsion

A mixture of the soybean oil based alkyd resin prepared in example 11 (100 g) and the maleic modified soybean oil prepared in example 10 (50 g) was mixed and warmed at 120° C. for 3 hours. The mixture was allowed to cool to 100° C. and water (2.5 g) was added and heating and mixing were continued for 2 hours at 100° C., whereby the acid number was 15. Then isopropyl alcohol (42 g) was added and the mixture was allowed to cool to a temperature of 50° C. The pH of the solution was adjusted to 7 with an aqueous ammonia solution. Water was added during 3 hours into the resin mixture, and emulsifying was carried out after each addition of water with Ultra Turrax homogeniser. The dry matter content of the emulsion was 40%.

### Example 13

### Modifying of Linen Seed Oil with Maleic Anhydride

Linen seed oil (400 g, 0.459 mol) was warmed to 180° C. Maleic anhydride (27.0 g, 0.275 mol, 20 mole %) was added in small portions during 2 hours, then the reaction mixture was warmed to 200° C. and agitated for a further 3 hours. No unreacted maleic anhydride was observed in the NMR analysis of the reaction product (419 g).

### Example 14

### Preparation of Linen Seed Oil Based Alkyd Resin

Alkyd resin was prepared from linen seed oil (300 g), trimethylolpropane (93.5 g) and isophthalic acid (130.0 g). The reaction mixture of linen seed oil and trimethylolpropane was warmed to a temperature of 200° C. with stirring under nitrogen atmosphere, after which lithium hydroxide monohydrate (0.304 g) was added. The warming was continued to 250° C., at which the reaction mixture was kept for 2 hours. The reaction mixture was cooled to 170° C. and isophthalic acid was added. The reaction mixture was warmed again to 240-260° C. and the progress of the reaction was followed with acid number and viscosity. The reaction time after addition of the isophthalic acid was 3.5 hours. From the cooled product (430.3 g) acid number (17) and viscosity (6.0 Poise/100° C., R.E.L.) were determined.

### Example 15

### Condensation of Maleic Anhydride-Modified Linen Seed Oil to Linen Seed Oil Based Alkyd Structure and Preparation of Emulsion

A mixture of the linen seed oil based alkyd prepared according to example 14 (350 g, acid number 16 and viscosity 6.0 Poise at 100° C.) and the maleic modified linen seed oil prepared in example 13 (175 g) was agitated for 3 hours at 120° C. Water (8.75 g) was added and agitating was continued for 2 hours at 100° C., whereby the acid number was 20. Then isopropyl alcohol (182 g) was added and the mixture was allowed to cool to a temperature of 50° C. The pH of the solution was adjusted to 7 with an aqueous ammonia solution. Emulsifying was carried out by adding water in small portions during 3 hours into the resin mixture which was stirred vigorously and warmed at 50° C. Emulsifying was carried out after each addition of water with Ultra Turrax homogeniser. The dry matter content of the emulsion was 42% and pH 6.8.

### Example 16

### Condensation Of Maleic Anhydride-Modified Tall Oil Fatty Acid Mixture to Alkyd Resin Based on Tall Oil Fatty Acid and Preparation of Emulsion

A mixture of the alkyd of example 5 (400 g) and the maleic modified tall oil fatty acid mixture of example 1 (200 g) was warmed for 3 hours at 120° C. Water (10 g) was added and warming and agitating were continued for 2 hours at 100° C.:ssa, whereby acid number was 89. Then isopropyl alcohol (182 g) was added and the mixture was allowed to cool to room temperature. The pH of the solution was adjusted to about 7 with an aqueous NH₃ solution. Emulsifying was carried out by adding water in small portions during 3 hours into the resin mixture, which was stirred vigorously and warmed at 50° C., after each addition of water the mixture was emulsified with Ultra Turrax homogeniser. The dry matter content of the final emulsion was 42% and pH 7.

### Example 17

### Condensation of Maleic Anhydride-Modified Tall Oil Fatty Acid Mixture to Alkyd Resin Based on Tall Oil Fatty Acid/Conjugated Tall Oil Fatty Acid and Preparation of Emulsion

A mixture of the alkyd prepared in example 8 (100 g,) and the maleic modified tall oil fatty acid mixture of example 1 (50 g) was heated for 3 hours at 120° C. (Ar bubbling). Water (2.5 ml) was added and the agitating was continued for 2 hours at 100° C., whereby the acid number was 85. Then isopropanol (45.5 g) was added and the mixture was allowed to cool to 50° C. The pH of the product was adjusted to about 7 with an aqueous NH₃ solution (about 28-30% NH₃). Emulsifying was carried out by adding water (80 g) in small portions during 3 hours into the resin mixture (100 g), which was agitated vigorously and warmed at 50° C. Emulsifying was carried out after each addition of water with Ultra Turrax homogeniser. The pH of the emulsion was 7.8 and dry matter content 42%.

### Example 18

### Preparation of Emulsion from Maleic Anhydride-Modified Tall Oil Based Alkyd Resin

The maleic modified alkyd of example 6 (acid number 19.7 mgKOH/g and viscosity 4.7 Poise at 50° C., 200 g) was warmed to 100° C. and 3.5 g of water were added to it and agitating was continued for further 2 hours at 100° C. Acid number of the reaction mixture was determined (21.6 mgKOH/g). 60 g of isopropanol was added and the mixture was allowed to cool, the pH was adjusted to a value of about 7 with an aqueous NH₃ solution. Emulsifying was carried out by adding water (210 g altogether) in small portions during 3 hours while stirring and warming the product mixture at 50° C. After each addition of water homogenisation was carried out with Ultra Turrax homogeniser. The pH of the to room temperature cooled emulsion was 6.5.

### Example 19

### Preparation of Composite Board from Addition/Condensation Product of Maleic Modified Linen Seed Oil and Linen Seed Oil Based Alkyd

A composite board was manufactured using 150 g (about 20% by weight, calculated from the dry matter) of the in water emulsified addition/condensation product of maleic modified linen seed oil and linen seed oil based alkyd prepared in example 15, and about 80% by weight of wood fibre (fibre type Pitesti) and 50 grams of water.

The compounding time (admixing) was 30 min, adaptation time in press ram 3 min, hot moulding temperature 156-161° C. and time 40 min, conditioning 60 min, total time 2 hours 13 min, thickness of the board 4.1 mm. Thus a ready composite board was obtained having a density of 1089-1097 kg/mc, moisture content 4.6-5.5%, swelling during 24 hours 19-21% of thickness, internal bond strength 0.02-0.10 N/mm² and flexural strength 18.4-27.8 N/mm².

### Example 20

### Preparation of Tall Oil Based Alkyd Resin

Alkyd resin was prepared from tall oil fatty acids (372.6 g), isophthalic acid (55.9 g) and pentaerythritol (71.5 g). All starting materials were weighed into a reaction vessel and the reaction mixture was mixed and warmed at 240-260° C. with bubbling nitrogen below the surface of the reaction mixture. The progress of the reaction was followed with acid number, and when the reaction mixture became clear, also with viscosity. The reaction was boiled for 7 hours. The acid number of the cooled product (421.3 g) was 5 and viscosity 5.6 Poise/50° C., R.E.L. and 10305 cP/RT, Brookfield.

### Example 21

### Condensation of Maleic Anhydride-Modified Tall Oil Fatty Acid Mixture to Alkyd Resin Based on Tall Oil Fatty Acid and Preparation of Emulsion

A mixture of the alkyd of example 20 (100 g) and the maleic modified tall oil fatty acid mixture of example 2 (50 g) was heated for 3 hours at 120° C. Water (2.5 g) was added and the heating and mixing were continued for 2 hours at 100° C., after which the mixture was allowed to cool to room temperature, whereby the acid number was 84. The pH of the solution was adjusted to 7 with a 25% aqueous NH₃ solution. Emulsifying was carried out by adding water drop wise during one hour to the resin mixture, which was stirred and warmed at 50° C. Finally, homogenisation was carried with Ultra Turrax homogeniser (1 min/13500 rpm). The dry matter content of the emulsion was 45% and pH 7.

### Example 22

### Condensation of Maleic Anhydride-Modified Tall Oil Fatty Acid Mixture to Alkyd Resin Based on Tall Oil Fatty Acid/Conjugated Tall Oil Fatty Acid and Preparation of Emulsion

A mixture of the alkyd of example 8 (100g) and the maleated tall oil fatty acid mixture of example 2 (50g) was heated for 3 hours at 120° C. Water (2.5 g) was added and the heating and agitating were continued for 2 hours at 100° C., after which the mixture was allowed to cool to room temperature, whereby the acid number was 93. The pH of the solution was adjusted to 7 with 25% aqueous NH₃ solution. Emulsifying was carried out by adding water dropwise during one hour into the resin mixture, which was stirred and warmed at 50° C. Finally a homogenisation was carried out with an Ultra Turrax homogeniser (1 min/13,500 rpm). The dry matter content of the emulsion was 45% and pH 7.

### Example 23

### Preparation of Fibre-Board (Composite Board) from Addition/Condensation Product of Maleic Modified Linen Seed Oil and Alkyd Based on Linen Seed Oil

A composite board was manufactured using 150 g of the in water emulsified addition/condensation product (prepared in example 15) of maleic modified linen seed oil and linen seed oil based alkyd, and 800 g of wood fibre (80% by weight, beech, fibre type Pitesti, the moisture content of the fibre 8-10%) and 50 g of water. The compounding time (admixing) was 30 min, adaptation time in press ram 3 min, hot molding temperature 166-168° C., pressure 2-4.9 MPa and time 40 min, conditioning 60 min, total time 2 hours 13 min, thickness of the board 4 mm. Thus a ready composite board was obtained having density of 1072-1123 kg/m³, moisture content 4.4-5.8%, swelling during 24 hours 9-16% of thickness, internal bond strength 0.33-0.76 N/mm² and flexural strength 24.9-39.7 N/mm².

### Example 24

### Preparation of Fibre-Board (Composite Board) from Addition/Condensation Product of Maleic Modified Linen Seed Oil and Alkyd Based on Linen Seed Oil

A composite board was manufactured using 200 g of in water emulsified addition/condensation product (prepared in example 15) of maleic maodified linen seed oil and alkyd based on linen seed oil, 800 g of wood fibre (80% by weight, beech, fibre type Pitesti, moisture content of the fibre 13%). The compounding time (admixing) was 30 min, adaptation time in press ram 3 min, hot molding temperature 160° C., pressure 3.5-4.9 MPa and time 34 min, conditioning 60 min, total time 2 hours 7 min, thickness of the board 2.5 mm. Thus a ready composite board obtained having density of 952-1014 kg/m³, moisture content 4.4-5.3%, swelling during 24 hours 16-28% of thickness, internal bond strength 0.72 N/mm² and flexural strength 12.2-28.3 N/mm².

### Example 25

### Modifying of Linen Seed Oil with Maleic Anhydride

Linen seed oil (2000 g) was warmed to 180° C. Maleic anhydride (134.9 g) was added in small portions during 2 hours, then the reaction mixture was warmed to 200° C. and agitated (600 rpm) for further 3 hours. No unreacted maleic anhydride was observed in the NMR analysis of the product (1666 g). The acid number of the product was 35 and viscosity 1.0 Poise/25° C., R.E.L.

### Example 26

### Preparation of Linen Seed Oil Based Alkyd Resin

Alkyd resin was prepared from linen seed oil (450 g), trimethylolpropane (140.3 g) and isophthalic acid (195.0 g). A mixture of linen seed oil and trimethylolpropane was warmed to 200° C. with agitating under N₂ atmosphere, then lithium hydroxide monohydrate (0.752 g) was added. The warming was continued to 250° C., at which the reaction mixture was kept for 3 hours, then the mixture was cooled to 170° C. and isophthalic acid was added. The reaction mixture was warmed to about 220-250° C. and the progress of the reaction was followed with acid number and viscosity. The reaction time after addition of isophthalic acid was 4 hours. The acid number of the cooled product (703.3 g) was 15 and viscosity 4.0 Poise/100° C., R.E.L.

### Example 27

### Condensation of Maleic Anhydride-Modified Linen Seed Oil to Alkyd Based on Linen Seed Oil and Preparation of Emulsion

A mixture of the alkyd of example 26 (400 g) and the maleic modified linen seed oil of example 25 (200 g) was agitated for 3 hours at 120° C. Water (10 g) was added and the agitating was continued for 2 hours at 100° C. The mixture was allowed to cool to room temperature (acid number 23, viscosity 3.2 Poise/100° C.). The pH of the solution was adjusted to about 7 with a 25% aqueous NH₃ solution. Emulsifying was carried out in a 2000 ml glass reactor by slowly adding water. The resin product (500 g) was added into the reactor and warmed agitating (300 rpm) to 50° C., then water (50° C.) (900 g) was pumped slowly during 2.5 hours into the resin mixture. After addition of the water the mixture was allowed to cool to room temperature still stirring. The dry matter content of the ready emulsion was 35% and pH 7.7.

1-18. (canceled)

19. A composite product, characterised in that it comprises 1-50% by weight of a modified natural fatty acid based hybrid resin obtained as condensation product of natural fatty acid mixture or natural fatty acid ester mixture, modified with di- and/or oligo-carboxylic acid or anhydride or half ester, and alkyd resin based on natural fatty acid, and 99-50% by weight of natural material selected from cellulose, wood, wood fibre, linen, hemp, starch and other natural fibre or a combination thereof, and optionally 20-80% by weight of the natural material is replaced with material selected from the thermoplastics and optionally 30-70% by weight of the modified natural fatty acid based hybride resin is replaced with binding agent or adhesive originating from nature.

20. The composite product according to claim 19, characterised in that it comprises 5-30% by weight of modified natural fatty acid based hybride resin and 95-70% by weight of natural material and optionally material replacing it.

21. The composite product according to claim 19, characterised in that the thermoplastics is selected from the group consisting of polyolefins, polyamides, polyesters, polyethylene terephthalates (PET), polylactides (PLA) and equivalent polymers.

22. The composite product according to claim 19, characterised in that the thermoplastics is recycled material.

23. The composite product according to claim 19, characterised in that the di- and/or oligo-carboxylic acid or anhydride or half ester is selected from the group consisting of itaconic anhydride, C2-C18 alkylene maleic anhydrides, C2-C18 alkylene maleic acids, maleic acid, maleic anhydride, fumaric acid, fumaric anhydride, itaconic acid as well as half esters of above mentioned acids and the natural fatty acid mixture or natural fatty acid ester mixture comprises a fatty acid mixture or fatty acid ester mixture selected from the group consisting of tall oil fatty acids, suberin fatty acids, cutin fatty acids, plant oils and their mixtures.

24. The composite product according to claim 19, characterised in that the natural fatty acid based alkyd resin is selected from the group of alkyd resins prepared by condensing 20-80% by weight of fatty acid starting material or a mixture thereof, 1-45% by weight of one or more polyols, 10-45% by weight of one or more polybasic acid and optionally 0-15% by weight of one or more monobasic acid.

25. The composite product according to claim 19, characterised in that the alkyd resin based on natural fatty acids is modified with maleic anhydride.

26. The composite product according to claim 24, characterised in that the fatty acid starting material is selected from the group consisting of tall oil fatty acids, suberin fatty acids, cutin fatty acids, plant oils and their mixtures, the polyol is selected from the group consisting of glycerol, pentaerythritol, trimethylolpropane and neopentyl glycol, the polybasic acid is selected from the group consisting of di- and polyacids and their anhydrides, and the monobasic acid is selected from the group consisting of benzoic acid and valeric acid.

27. A method for the preparation of a composite product according to claim 19, characterised in that in the method 1-50% by weight of a modified natural fatty acid based hybride resin, either as such or as an aqueous emulsion, and 99-50% by weight of natural material selected from the group consisting of cellulose, wood, wood fibre, linen, hemp, starch or other natural fibre or a combination thereof, are mixed, and 20-80% by weight of the natural material can be substituted with other material selected from the group consisting of thermoplastics, and 30-70% by weight of the modified natural fatty acid based hybride resin can optionally be replaced with binding agent or adhesive originating from nature, a product is formed and the product is cured with aid of heat at 100-250° C.

28. The method according to claim 27, characterised in that in the method 5-30% by weight of the modified natural fatty acid based hybride resin and 95-70% by weight of natural material, optionally its replacement material are mixed, a product is formed and the product is cured with aid of heat at 120-200° C.

29. The method according to claim 27, characterised in that the thermoplastics is selected from the group consisting of polyolefins, polyamides, polyesters, polyethylene terephthalates (PET), polylactides (PLA) and equivalent polymers.

30. The method according to claim 27, characterised in that the thermoplastics is recycled material.

31. The method according to claim 27, characterised in that the product is formed and cured by extrusion or hot-pressing.

32. The method according to claim 27, characterised in that the modified natural fatty acid based hybride resin is emulsified/dispersed in water before adding to the composite product.

33. The method according to claim 32, characterised in that the pH of the modified natural fatty acid based hybride resin is adjusted between 6-10 with base and the hybride resin solution is then dispersed/emulsified in water at a temperature of 15-80° C., and optionally with 0-30% by weight of a co-solvent.

34. The method according to claim 32, characterised in that the dispersing/emulsifying is carried out with mixers and/or homogenisers, which provide a speed of rotation of 100-50000 rpm.

35. The method according to claim 33, characterised in that the co-solvent is selected from the group consisting of isopropanol, 2-butoxyethanol, methoxypropanol and propylene glycol butyl ether.
